(19) United States
(12) Patent Application Publication
(10) Pub. No.: US 2026/0188831 A1
(43) Pub. Date: Jul. 2, 2026

(54) BATTERY MODULE

(71) Applicants: Hyundai Motor Company, Seoul (KR); Kia Corporation, Seoul (KR)

(72) Inventors: Seok Eun Yoon, Hwaseong-si (KR); Jun Young Kang, Hwaseong-si (KR); Young Hoo Oh, Hwaseong-si (KR)

(21) Appl. No.: 19/292,295

(22) Filed: Aug. 6, 2025

(30) Foreign Application Priority Data
Jan. 7, 2025 (KR) 10-2025-0002491

(51) Int. Cl. H01M 50/342; H01M 50/209; H01M 50/503; H01M 50/507

(52) U.S. Cl. CPC H01M 50/3425; H01M 50/209; H01M 50/503; H01M 50/507

(57) ABSTRACT

A battery module according to the present disclosure includes a plurality of battery cells, a module housing configured to surround the plurality of battery cells, and a venting member formed on surfaces of the plurality of battery cells, wherein the venting member includes an outer venting sheet facing the plurality of battery cells and an inner venting sheet disposed between the outer venting sheet and the battery cell, formed on an area facing the battery cell, and including a notch portion having a thickness smaller than a thickness of a peripheral area.

### CROSS-REFERENCE TO RELATED APPLICATIONS

This application claims the benefit of priority to Korean Patent Application No. 10-2024-0002491, filed in the Korean Intellectual Property Office on Jan. 7, 2025, the entire contents of which are incorporated herein by reference.

### TECHNICAL FIELD

The present disclosure relates to a battery module.

### BACKGROUND

In recent years, as awareness of crisis of environment and depletion of petroleum resources has increased, research and development on electric vehicles, which are eco-friendly vehicles, have emerged.

An electric vehicle is a vehicle that moves using electricity as power and may include a battery pack. The battery pack may include a battery module having a plurality of battery cells.

When a fire occurs in a battery cell, as the fire spreads to other adjacent battery cells, a thermal runaway phenomenon may occur in the battery module or the battery pack. To prevent this, there is an increasing need for a structure for guiding a foreign material or a high-pressure fluid due to the fire on a structure of the battery module or the battery pack in a different direction other than another battery cell adjacent to the battery cell in which the fire occurs.

### SUMMARY

The present disclosure has been made to solve the above-mentioned problems occurring in the prior art while advantages achieved by the prior art are maintained intact.

An aspect of the present disclosure provides a battery module for preventing foreign materials or high-pressure fluids from being introduced into another battery cell adjacent to a battery cell in which a fire occurs when the fire occurs in the battery cell.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes a plurality of battery cells, a module housing configured to surround the plurality of battery cells, and a venting member formed on surfaces of the plurality of battery cells, wherein the venting member includes an outer venting sheet facing the plurality of battery cells and an inner venting sheet disposed between the outer venting sheet and the plurality of battery cells, formed on an area facing the plurality of battery cells, and including a notch portion having a first thickness that is smaller than a second thickness of a peripheral area.

The venting member may further include a support member that is supported by the inner venting sheet and supports the outer venting sheet.

The support member may include a communication hole formed on an area facing the notch portion.

The support member may further include a support body in which the communication hole is formed and a support protrusion protruding from the support body toward the outer venting sheet outside a circumference of the communication hole.

The support body may be attached onto an outer venting surface of the outer venting sheet, which faces the inner venting sheet.

The support protrusion may be attached onto an inner venting surface of the inner venting sheet, which faces the outer venting sheet.

The plurality of battery cells may be stacked in a direction, the support protrusion may be provided as a plurality of support protrusions, and the plurality of support protrusions may be spaced apart from each other in the direction.

The plurality of battery cells may be stacked in a first direction, the battery module according to an embodiment of the present disclosure may further include a busbar extending in the first direction so that the busbar is electrically connected to the plurality of battery cells, and the support member may support the busbar.

The support member may include a support body including a communication hole formed on an area facing the notch portion, and the support member may support the busbar on a side of the communication hole in a second direction intersecting the first direction.

The plurality of battery cells may be stacked in a first direction, and the notch portion may be positioned on a central area of the inner venting sheet in a second direction intersecting the first direction.

A battery cell of the plurality of battery cells may include a venting part formed on an area facing the notch portion.

The venting member may be supported by the module housing.

The inner venting sheet may include mica, and the outer venting sheet is formed of a polyimide material.

The support member may be formed of an injection-moldable material.

According to an aspect of the present disclosure, a battery pack includes a battery module includes a plurality of battery cells, a module housing configured to surround the plurality of battery cells and a venting member formed on surfaces of the plurality of battery cells and including an outer venting sheet facing the plurality of battery cells and an inner venting sheet disposed between the outer venting sheet and the plurality of battery cells, formed on an area facing the plurality of battery cells, and including a notch portion having a first thickness that is smaller than a second thickness of a peripheral area and a pack cover spaced a distance apart from the outer venting sheet to create a space between the pack cover and the outer venting sheet.

The venting member may further include a support member supported by the inner venting sheet and configured to support the outer venting sheet.

The support member may include a communication hole formed on an area facing the notch portion.

According to an aspect of the present disclosure, a battery module includes a plurality of battery cells stacked in a first direction within the battery module, a module housing surrounding the plurality of battery cells and a plurality of venting members formed on respective surfaces of the plurality of battery cells and each venting member of the plurality of venting members includes an respective outer venting sheet facing the plurality of battery cells and a respective inner venting sheet, and each respective inner venting sheet is disposed between the respective outer venting sheet and the plurality of battery cells, formed on an area facing the plurality of battery cells and includes a notch portion having a first thickness that is smaller than a second thickness of a peripheral area and being positioned on a central area of the respective inner venting sheet in a second direction intersecting the first direction.

Each battery cell of the plurality of battery cells may include a respective venting part facing the notch portion.

Each of the plurality of venting members may be supported by the module housing.

### BRIEF DESCRIPTION OF THE DRAWINGS

The above and other aspects, features and advantages of the present disclosure will be more apparent from the following detailed description taken in conjunction with the accompanying drawings:

FIG. 1 is a perspective view of a battery module according to an embodiment of the present disclosure;

FIG. 2 is a perspective view of a battery cell according to the embodiment of the present disclosure;

FIG. 3 is a perspective view of a support member according to the embodiment of the present disclosure;

FIG. 4 is a plan view of a support member and an inner venting sheet of a venting member according to the embodiment of the present disclosure;

FIG. 5 is a vertical cross-sectional view of the battery module according to the embodiment of the present disclosure;

FIG. 6 is an enlarged view of the vertical cross-sectional view illustrated in FIG. 5;

FIG. 7 is an enlarged view of a state in which a notch portion of the inner venting sheet is damaged according to the embodiment of the present disclosure; and

FIG. 8 is a perspective view of a support member according to another embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function will be omitted when it is determined that the detailed description interferes with the understanding of the embodiment of the present disclosure.

Further, in describing the components of the embodiments of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

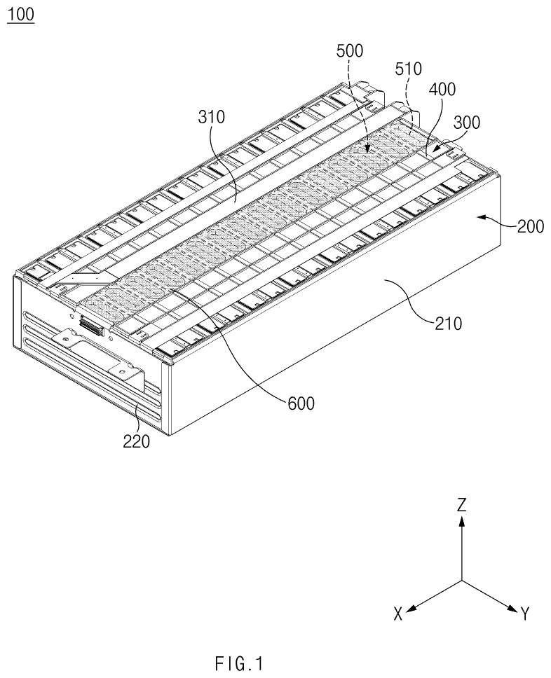

Hereinafter, embodiments of the present disclosure will be described in detail with reference to FIGS. 1 to 8. Hereinafter, a first direction may be an X direction or an opposite direction to the X direction, a second direction may be an Y direction or an opposite direction to the Y direction, and a third direction may be a Z direction or an opposite direction to the Z direction (e.g., as shown in FIG. 1).

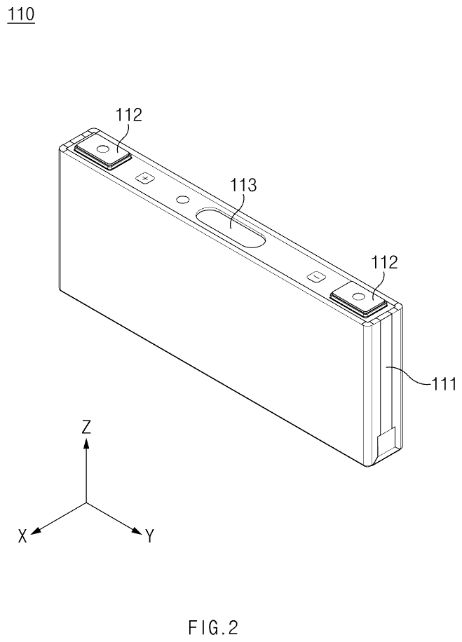

FIG. 1 is a perspective view of a battery module according to an embodiment of the present disclosure. FIG. 2 is a perspective view of a battery cell according to the embodiment of the present disclosure.

Referring to FIGS. 1 and 2, a battery module 100 may include a module housing 200 and a venting member 300 mounted on the module housing 200.

The battery module 100 may include a plurality of battery cells 110 surrounded by the module housing 200.

The module housing 200 may be formed to surround the plurality of battery cells 110 stacked in the first direction (the X direction or the opposite direction to the X direction).

The module housing 200 may include side plates 210 arranged on both sides of the plurality of battery cells 110 in the second direction (the Y direction or the opposite direction to the Y direction) and end plates 220 arranged on both sides of the plurality of battery cells 110 in the first direction (the X direction or the opposite direction to the X direction).

Each of the side plate 210 and the end plate 220 may be provided in a pair. The pair of side plates 210 may apply a force so that the pair of end plates 220 are pressed toward each other from the outside of the pair of end plates 220.

Due to this structure, the plurality of battery cells 110 stacked in the first direction (the X direction or the opposite direction to the X direction) may be pressed between the pair of end plates 220.

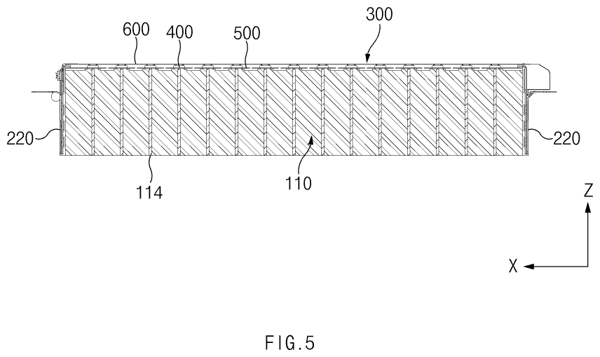

Further, a surface pressure member 114 (see FIG. 5) may be formed between the plurality of battery cells 110. The surface pressure member 114 may press the battery cell 110 in addition to the end plate 220. The surface pressure member 114 may be formed of a material having ensured heat resistance or ensured fire resistance.

The battery cell 110 may be formed as a prismatic cell as illustrated in FIG. 2, but the present disclosure is not limited thereto.

The battery cell 110 may include a stack-type cell 111 stacked in the first direction (the X direction or the opposite direction to the X direction). The battery cell 110 may include an electrode terminal 112 and a venting part 113 provided on one side (the Z direction) of the stack-type cell 111 in the third direction. When a pressure of the stack-type cell 111 is increased, the venting part 113 may be formed to be torn by applying deformation.

The venting member 300 may be formed on one side (one side in the Z direction) of the venting part 113 in the third direction. The venting member 300 may be formed on one surface facing one side (one side in the Z direction) of the plurality of battery cells 110 in the third direction.

The venting member 300 according to the embodiment of the present disclosure may have a structure that supports a busbar 310 electrically connected to the electrode terminal 112 of the battery cell 110.

The venting member 300 may be formed on one surface that is one side (the Z direction) of the plurality of battery cells 110 in the third direction. The venting member 300 may be supported by the module housing 200. The venting member 300 may be supported by the side plate 210 or the end plate 220 of the module housing 200.

The venting member 300 may include a support member 400, an inner venting sheet 500, and an outer venting sheet 600.

The support member 400 may support the busbar 310, and the outer venting sheet 600 may be stacked on at least one area of the support member 400. The outer venting sheet 600 may be disposed to face the plurality of battery cells 110.

The inner venting sheet 500 may be disposed between the outer venting sheet 600 and the battery cell 110. The inner venting sheet 500 may include a notch portion 510 having a smaller thickness than that of a peripheral area. The notch portion 510 may be formed on an area of the inner venting sheet 500 facing the battery cell 110.

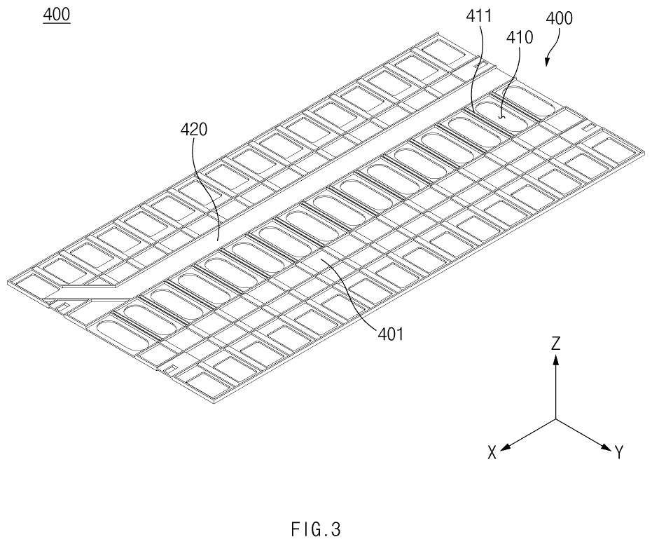

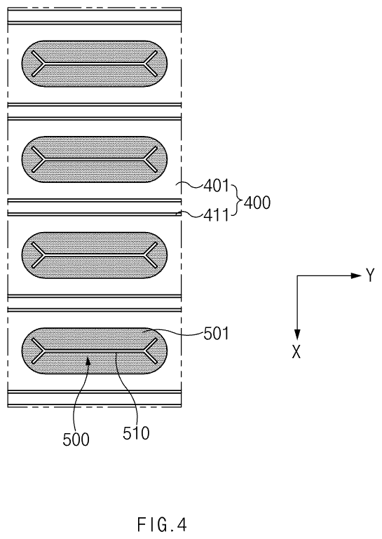

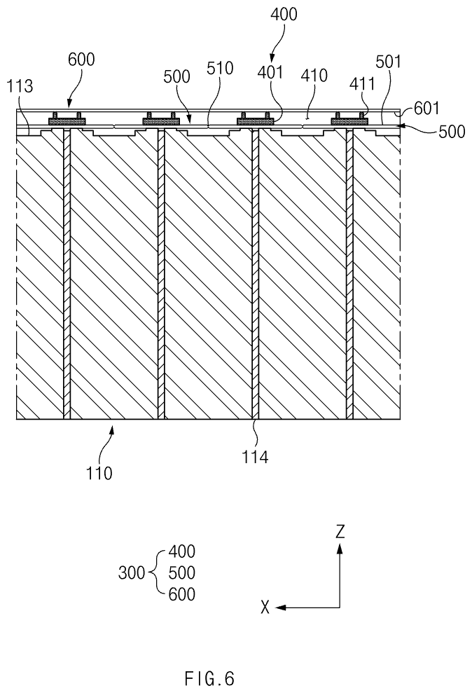

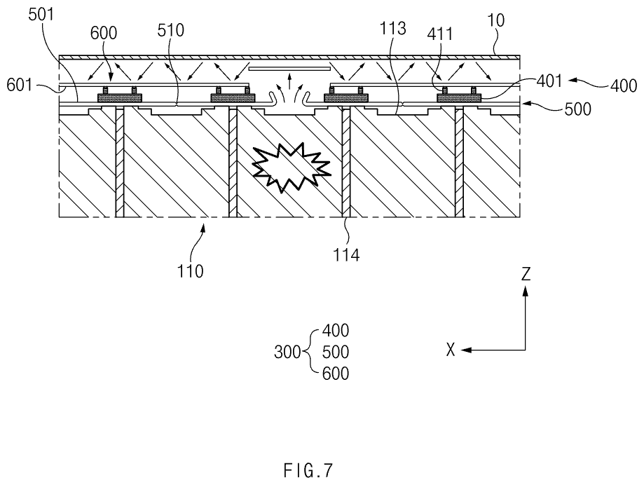

FIG. 3 is a perspective view of a support member according to the embodiment of the present disclosure. FIG. 4 is a plan view of a support member and an inner venting sheet of a venting member according to the embodiment of the present disclosure. FIG. 5 is a vertical cross-sectional view of the battery module according to the embodiment of the present disclosure. FIG. 6 is an enlarged view of the vertical cross-sectional view illustrated in FIG. 5. FIG. 7 is an enlarged view of a state in which a notch portion of the inner venting sheet is damaged according to the embodiment of the present disclosure.

Referring to FIGS. 3 to 7, the venting member 300 may include the support member 400, the inner venting sheet 500, and the outer venting sheet 600.

The support member 400 may be a component for supporting the busbar 310 (see FIG. 1). The support member 400 may be disposed between the inner venting sheet 500 and the outer venting sheet 600. The support member 400 may be supported by the inner venting sheet 500 and may support the outer venting sheet 600.

The inner venting sheet 500 may be disposed between the support member 400 and the battery cell 110, and the support member 400 may be disposed between the inner venting sheet 500 and the outer venting sheet 600.

The support member 400 may include a support body 401 and a communication hole 410 formed on the support body 401.

The communication hole 410 may be formed in a central area of the support body 401 in the second direction (the Y direction or the opposite direction to the Y direction). The communication hole 410 may be provided as a plurality of communication holes 410, which may be formed to be spaced apart from each other in the first direction (the X direction or the opposite direction to the X direction).

The communication hole 410 may be formed on an area of the support body 401 facing the venting part 113 (see FIG. 2). The communication hole 410 may be formed on an area facing the notch portion 510. The communication hole 410 may be formed in an elliptical shape.

The support member 400 may include the support body 401 and a support protrusion 411 protruding from the support body 401 toward the outer venting sheet 600. The support protrusion 411 may be formed outside a circumference of the communication hole 410.

The support protrusion 411 may be provided as a plurality of support protrusions 411, and the plurality of support protrusions 411 may be spaced apart from each other in the first direction (the X direction or the opposite direction to the X direction). In more detail, the pair of support protrusions 411 provided on both sides of the one communication hole 410 in the first direction (the X direction or the opposite direction to the X direction) based on the one communication hole 410 may be spaced apart from each other in the first direction (i.e., opposite to the X direction).

The support member 400 may support the busbar 310 on the other side (the opposite direction to the Y direction) of the communication hole 410 in the second direction.

The support member 400 may include a busbar support area 420 provided on the other side (the opposite direction to the Y direction) of the communication hole 410 in the second direction. The busbar support area 420 may support the busbar 310 at a position that does not overlap the communication hole 410. The busbar 310 may be disposed on one side of the communication hole 410. The busbar 310 may be welded to the busbar support area 420.

The pair of busbars 310 may be connected to a pair of electrode terminals 112 (see FIG. 2), respectively. The pair of busbars 310 may extend in the first direction (the X direction or the opposite direction to the X direction) in which the battery cells 110 are stacked, so that the busbars 310 are connected to the plurality of battery cells 110.

The inner venting sheet 500 may include the notch portion 510 formed on an area facing each of the battery cells 110. The notch portion 510 may be a portion of the inner venting sheet 500, which has a smaller thickness than that of the peripheral area.

The notch portion 510 may be formed at a position facing the venting part 113 (see FIG. 2). In other expressions, the battery cell 110 may include the venting part 113 formed on an area facing the notch portion 510.

The notch portion 510 may be positioned on a central area of the inner venting sheet 500 in the second direction (the Y direction or the opposite direction to the Y direction).

The support body 401 of the support member 400 may be disposed on an area facing the surface pressure member 114. The communication hole 410 of the support member 400 may be formed in an area between the pair of surface pressure members 114 adjacent to each other.

The communication hole 410 may be formed on an area facing the venting part 113 and the notch portion 510. That is, the venting part 113, the notch portion 510, and the communication hole 410 may be formed on areas facing each other.

Meanwhile, the support member 400 may be attached onto an outer venting surface 601 of the outer venting sheet 600, which faces the inner venting sheet 500.

The support member 400 may be attached onto an inner venting surface 501 of the inner venting sheet 500, which faces the outer venting sheet 600.

In more detail, the support body 401 of the support member 400 may be attached onto the inner venting surface 501 of the inner venting sheet 500, which faces the outer venting sheet 600. Here, the inner venting surface 501 may be one surface facing the other side of one side of the inner venting sheet 500, which faces the battery cell 110.

The support protrusion 411 of the support member 400 may be attached onto the outer venting surface 601 of the outer venting sheet 600, which faces the inner venting sheet 500. Here, the outer venting surface 601 may be one surface facing one side of the outer venting sheet 600, which faces the battery cell 110.

Attachment between the support member 400 and the inner venting sheet 500 may be achieved by a separately provided adhesive member having ensured high heat resistance, and an adhesive may be applied onto the inner venting surface 501 and the outer venting surface 601, so that the support member 400 may be attached onto the inner venting sheet 500 and the outer venting sheet 600.

The support member 400 may be formed of an injection-moldable material. The inner venting sheet 500 may be formed of a mica having ensured heat resistance. The outer venting sheet 600 may be formed of a polyimide material.

A polyimide tape may have an adhesive force by itself, and the outer venting sheet 600 may be attached to the support protrusion 411 by itself. Meanwhile, materials of the inner venting sheet 500 and the outer venting sheet 600 are not limited thereto, and the outer venting sheet 600 may be formed of an injection-moldable thin film, an injection-moldable film, or the like.

Meanwhile, as illustrated in FIG. 7, when a fire occurs in any one of the plurality of battery cells 110, the notch portion 510 may be damaged by a pressure of the battery cell 110.

When the notch portion 510 is damaged, the inner venting sheet 500 may be torn with respect to the notch portion 510, and the outer venting sheet 600 may be separated from the support protrusions 411 based on the pair of support protrusions 411 forming the communication hole 410 due to the pressure caused by the fire.

According to this principle, foreign substances or high-pressure fluids caused by the fire may be discharged through a space between the outer venting sheet 600 and a pack cover 10, and not a space between the outer venting sheet 600 and the inner venting sheet 500.

Thus, this structure may prevent foreign substances or fluids caused by the fire from being introduced into another battery cell 110 adjacent to the battery cell 110 in which the fire occurs by the outer venting sheet 600, thereby preventing a thermal runaway phenomenon.

Further, due to the fire-resistant inner venting sheet 500, even when a high-temperature or high-pressure fluid flows through the space between the outer venting sheet 600 and the inner venting sheet 500, the fluid may be prevented from being introduced into another battery cell 110.

Further, the surface pressure member 114 may be formed to have heat resistance, heat transfer between the battery cells 110 may be delayed, and thus a thermal runaway phenomenon inside the battery module 100 may be prevented.

Meanwhile, it is illustrated that the outer venting sheet 600 extends in the first direction (the X direction or the opposite direction to the X direction), but the present disclosure is not limited thereto, and each of the plurality of outer venting sheets 600 provided to correspond to the number of communication holes 410 may be attached to the support protrusion 411.

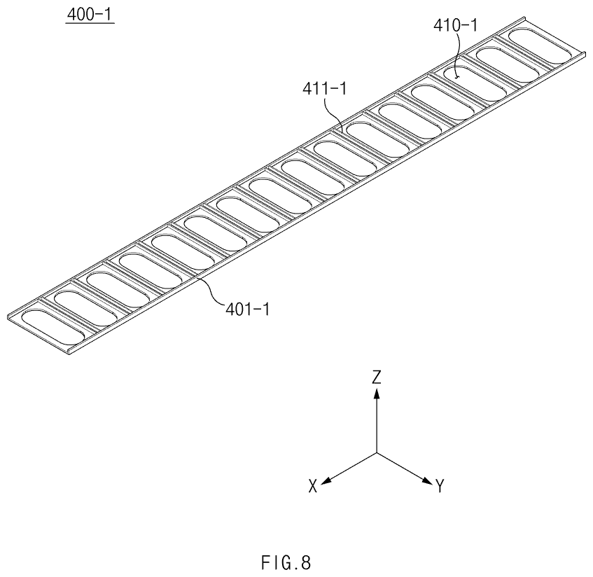

FIG. 8 is a perspective view of a support member according to another embodiment of the present disclosure.

In certain embodiments, a support member 400-1 may be a separate component other than a component supporting the busbar 310 (see FIG. 1).

The support member 400-1 may be provided only on a central area of the battery module 100 in the second direction (the Y direction or the opposite direction to the Y direction).

The support member 400-1 may include a support body 401-1 in which a communication hole 410-1 is formed, and a support protrusion 411-1 protruding from the support body 401-1.

The description of the support body 401-1, the communication hole 410-1, and the support protrusion 411-1 of the support member 400-1 refers to the description of the support body 401, the communication hole 410, and the support protrusion 411 of the support member 400.

The present technology may prevent a thermal runaway phenomenon of a battery module by venting foreign materials or high-pressure gases caused by a fire to the outside of the battery module because an outer venting sheet is damaged as a notch portion of an inner venting sheet is damaged when the fire occurs in a battery cell.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the embodiments disclosed in the present disclosure are not intended to limit the technology spirit of the present disclosure but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A battery module comprising:
a plurality of battery cells;
a module housing configured to surround the plurality of battery cells; and
a venting member formed on surfaces of the plurality of battery cells,
wherein the venting member includes:
an outer venting sheet facing the plurality of battery cells; and
an inner venting sheet disposed between the outer venting sheet and the plurality of battery cells, formed on an area facing the plurality of battery cells, and including a notch portion having a first thickness that is smaller than a second thickness of a peripheral area.

2. The battery module of claim 1, wherein the venting member further includes:
a support member supported by the inner venting sheet and configured to support the outer venting sheet.

3. The battery module of claim 2, wherein the support member includes a communication hole formed on an area facing the notch portion.

4. The battery module of claim 3, wherein the support member further includes:
a support body in which the communication hole is formed; and
a support protrusion protruding from the support body toward the outer venting sheet outside a circumference of the communication hole.

5. The battery module of claim 4, wherein the support body is attached onto an outer venting surface of the outer venting sheet, which faces the inner venting sheet.

6. The battery module of claim 4, wherein the support protrusion is attached onto an inner venting surface of the inner venting sheet, which faces the outer venting sheet.

7. The battery module of claim 4, wherein:
the plurality of battery cells are stacked in a direction,
the support protrusion is provided as a plurality of support protrusions, and
the plurality of support protrusions are spaced apart from each other in the direction.

8. The battery module of claim 2, wherein:
the plurality of battery cells are stacked in a first direction,
the battery module further comprises a busbar extending in the first direction so that the busbar is electrically connected to the plurality of battery cells, and
the support member supports the busbar.

9. The battery module of claim 8, wherein:
the support member includes a support body including a communication hole formed on an area facing the notch portion, and
the support member supports the busbar on a side of the communication hole in a second direction intersecting the first direction.

10. The battery module of claim 1, wherein:
the plurality of battery cells are stacked in a first direction, and
the notch portion is positioned on a central area of the inner venting sheet in a second direction intersecting the first direction.

11. The battery module of claim 1, wherein a battery cell of the plurality of battery cells includes:
a venting part formed on an area facing the notch portion.

12. The battery module of claim 1, wherein the venting member is supported by the module housing.

13. The battery module of claim 1, wherein:
the inner venting sheet includes mica, and
the outer venting sheet is formed of a polyimide material.

14. The battery module of claim 2, wherein the support member is formed of an injection-moldable material.

15. A battery pack, comprising:
a battery module comprising:
a plurality of battery cells;
a module housing configured to surround the plurality of battery cells; and
a venting member formed on surfaces of the plurality of battery cells,
wherein the venting member includes:
an outer venting sheet facing the plurality of battery cells; and
an inner venting sheet disposed between the outer venting sheet and the plurality of battery cells, formed on an area facing the plurality of battery cells, and including a notch portion having a first thickness that is smaller than a second thickness of a peripheral area; and
a pack cover spaced a distance apart from the outer venting sheet to create a space between the pack cover and the outer venting sheet.

16. The battery pack of claim 15, wherein the venting member further includes:
a support member supported by the inner venting sheet and configured to support the outer venting sheet.

17. The battery module of claim 16, wherein the support member includes a communication hole formed on an area facing the notch portion.

18. A battery module comprising:
a plurality of battery cells stacked in a first direction within the battery module;
a module housing surrounding the plurality of battery cells; and
a plurality of venting members formed on respective surfaces of the plurality of battery cells,
wherein each venting member of the plurality of venting members includes:
an respective outer venting sheet facing the plurality of battery cells; and
a respective inner venting sheet,
wherein each respective inner venting sheet is:
disposed between the respective outer venting sheet and the plurality of battery cells;
formed on an area facing the plurality of battery cells; and
includes a notch portion having a first thickness that is smaller than a second thickness of a peripheral area and being positioned on a central area of the respective inner venting sheet in a second direction intersecting the first direction.

19. The battery module of claim 18, wherein each battery cell of the plurality of battery cells comprises a respective venting part facing the notch portion.

20. The battery module of claim 18, wherein each of the plurality of venting members is supported by the module housing.
